(19) United States
(12) Patent Application Publication
(10) Pub. No.: US 2026/0362131 A1
(43) Pub. Date: Nov. 12, 2026

(54) WIRELESS METHOD AND DEVICE THEREOF

(71) Applicant: ZTE CORPORATION, Shenzhen, Guangdong (CN)

(72) Inventors: Peilin LIU, Shenzhen (CN); Shilin YOU, Shenzhen (CN); Zhen XING, Shenzhen (CN); Yuze LIU, Shenzhen (CN); Yan LI, Shenzhen (CN)

(21) Appl. No.: 19/135,154

(22) PCT Filed: Feb. 13, 2023
(86) PCT No.: PCT/CN2023/075699

§ 371 Date: Jun. 3, 2025

(51) Int. Cl. H04W 12/06; H04W 12/041; H04W 12/0431; H04W 36/08; H04W 84/04

(52) U.S. Cl. CPC H04W 12/06; H04W 12/041; H04W 12/0431; H04W 36/08; H04W 84/042

(57) ABSTRACT

A wireless communication method for use in an anchor function is disclosed. The method comprises receiving, from an authentication server function, a first key registration request for a wireless terminal, wherein the first key registration request comprises a first serving network name of a first visited network and a first access type associated with the first visited network, wherein the first access type is one of a plurality of access types, and storing the first serving network name as a current network corresponding to the first access type for the wireless terminal.

### CROSS REFERENCE

This application is a National Stage Filing of the PCT International Application No. PCT/CN2023/075699 filed on Feb. 13, 2023, the entirety of which is herein incorporated by reference.

### TECHNICAL FIELD

This document is directed generally to wireless communications and in particular to 5G communications.

### BACKGROUND

According to the existing art, in multiple registration scenarios, a UE (user equipment) can be multiply registered in serving networks of different PLMNs (public land mobile networks). Though UE can connect to two different visited networks, the UE may leverage only one visited network to connect to a target AF, resulting in certain multiple registration problem in an AKMA (Authentication and Key Management for Applications) roaming scenario.

### SUMMARY

This document relates to methods, systems, and devices for multiple registrations, and in particular to methods, systems, and devices for multiple registrations in the AKMA roaming.

The present disclosure relates to a wireless communication method for use in an anchor function. The method comprises:
receiving, from an authentication server function, a first key registration request for a wireless terminal, wherein the first key registration request comprises a first serving network name of a first visited network and a first access type associated with the first visited network, wherein the first access type is one of a plurality of access types, and
storing the first serving network name as a current network corresponding to the first access type for the wireless terminal.

Various embodiments may preferably implement the following features:

Preferably, the plurality of access types comprises a trusted access type and an untrusted access type.

Preferably, the wireless communication method further comprises:
receiving, from an application function, a key acquisition request for the wireless terminal, and
transmitting key information of the wireless terminal to a plurality of network functions based on the current networks corresponding to the plurality of access types.

Preferably, the wireless communication method further comprises:
receiving, from an application function, a key acquisition request for the wireless terminal, and
transmitting key information of the wireless terminal to a first network function of the current network corresponding to the first access type.

Preferably, the wireless communication method further comprises:
receiving, from the authentication server function, a second key registration request for the wireless terminal, wherein the second key registration request comprises a second serving network name of a second visited network and a second access type associated with the second visited network, wherein the second access type is one of the plurality of access types and is different from the first access type, and
storing the second serving network name as a current network corresponding to the second access type for the wireless terminal.

Preferably, the wireless communication method further comprises:
receiving, from an application function, a key acquisition request for the wireless terminal, and
transmitting key information of the wireless terminal to a first network function of the current network corresponding to the first access type, and
transmitting the key information of the wireless terminal to a second network function of the current network corresponding to the second access type.

Preferably, the wireless communication method further comprises:
receiving, from the authentication server function, a third key registration request for the wireless terminal, wherein the third key registration request comprises a third serving network name of a third visited network and the first access type associated with the third visited network, and
storing the third serving network name as the current network corresponding to the first access type for the wireless terminal.

Preferably, the wireless communication method further comprises:
receiving, from an application function, a key acquisition request for the wireless terminal, and
transmitting key information of the wireless terminal to a third network function of the current network corresponding to the first access type, and
transmitting the key information of the wireless terminal to a second network function of the current network corresponding to the second access type.

Preferably, the first key registration request further comprises a first anchor key and a first key identifier, wherein method further comprises:
storing the first anchor key as a current anchor key of the wireless terminal, and
storing the first anchor key identifier as a current anchor key identifier of the wireless terminal.

Preferably, the wireless communication method further comprises:
receiving, from the authentication server function, a fourth key registration request for the wireless terminal, wherein the fourth key registration request comprises a second anchor key and a second key identifier,
storing the second anchor key as the current anchor key of the wireless terminal, and
storing the second anchor key identifier as the current anchor key identifier of the wireless terminal.

Preferably, the fourth key registration request is associated with a fourth visited network which has a fourth access type different from or the same with the first access type.

The present disclosure relates to a wireless communication method for use in an authentication server function. The method comprises: transmitting, to an anchor function, a first key registration request for a wireless terminal, wherein the first key registration request comprises a first serving network name of a first visited network and a first access type associated with the first visited network, wherein the first access type is one of a plurality of access types.

Various embodiments may preferably implement the following features:

Preferably, the plurality of access types comprises a trusted access type and an untrusted access type.

Preferably, the wireless communication method further comprises: transmitting, to the anchor function, a second key registration request for the wireless terminal, wherein the second key registration request comprises a second serving network name of a second visited network and a second access type associated with the second visited network, wherein the second access type is one of the plurality of access types and is different from the first access type.

Preferably, the wireless communication method further comprises: transmitting, to the anchor function, a third key registration request for the wireless terminal, wherein the third key registration request comprises a third serving network name of a third visited network and the first access type associated with the third visited network.

Preferably, the first key registration request further comprises a first anchor key and a first key identifier.

Preferably, the wireless communication method further comprises:
transmitting, to the anchor function, a fourth key registration request for the wireless terminal, wherein the fourth key registration request comprises a second anchor key and a second key identifier.

Preferably, the fourth key registration request is associated with a fourth visited network which has a fourth access type different from or the same with the first access type.

The present disclosure relates to a wireless device for an anchor function. The wireless device comprises:
a communication unit, configured to receive, from an authentication server function, a first key registration request for a wireless terminal, wherein the first key registration request comprises a first serving network name of a first visited network and a first access type associated with the first visited network, wherein the first access type is one of a plurality of access types, and
a processor, configured to store the first serving network name as a current network corresponding to the first access type for the wireless terminal.

Various embodiments may preferably implement the following feature:

Preferably, the processor is further configured to perform any of aforementioned wireless communication methods.

The present disclosure relates to a wireless device for authentication server function. The wireless device comprises:
a communication unit, configured to transmit, to an anchor function, a first key registration request for a wireless terminal, wherein the first key registration request comprises a first serving network name of a first visited network and a first access type associated with the first visited network, wherein the first access type is one of a plurality of access types.

Various embodiments may preferably implement the following feature:

Preferably, the wireless device further comprises a processor configured to perform any of aforementioned wireless communication methods.

The present disclosure relates to a computer program product comprising a computer-readable program medium code stored thereupon, the code, when executed by a processor, causing the processor to implement a wireless communication method recited in any one of foregoing methods.

The exemplary embodiments disclosed herein are directed to providing features that will become readily apparent by reference to the following description when taken in conjunction with the accompany drawings. In accordance with various embodiments, exemplary systems, methods, devices and computer program products are disclosed herein. It is understood, however, that these embodiments are presented by way of example and not limitation, and it will be apparent to those of ordinary skill in the art who read the present disclosure that various modifications to the disclosed embodiments can be made while remaining within the scope of the present disclosure.

Thus, the present disclosure is not limited to the exemplary embodiments and applications described and illustrated herein. Additionally, the specific order and/or hierarchy of steps in the methods disclosed herein are merely exemplary approaches. Based upon design preferences, the specific order or hierarchy of steps of the disclosed methods or processes can be re-arranged while remaining within the scope of the present disclosure. Thus, those of ordinary skill in the art will understand that the methods and techniques disclosed herein present various steps or acts in a sample order, and the present disclosure is not limited to the specific order or hierarchy presented unless expressly stated otherwise.

The invention is specified by the independent claims. Preferred embodiments are defined in the dependent claims. In the following description, although numerous features may be designated as optional, it is nevertheless acknowledged that all features comprised in the independent claims are not to be read as optional.

The above and other aspects and their implementations are described in greater detail in the drawings, the descriptions, and the claims.

### BRIEF DESCRIPTION OF THE DRAWINGS

FIG. 1 shows a schematic diagram of a network according to an embodiment of the present disclosure.

FIGS. 2A to 2C show schematic diagrams of a process according to an embodiment of the present disclosure.

FIG. 3 shows an example of a schematic diagram of a wireless terminal according to an embodiment of the present disclosure.

FIG. 4 shows an example of a schematic diagram of a wireless network node according to an embodiment of the present disclosure.

FIG. 5 shows a flowchart of a method according to an embodiment of the present disclosure.

FIG. 6 shows a flowchart of a method according to an embodiment of the present disclosure.

### DETAILED DESCRIPTION OF THE EMBODIMENTS

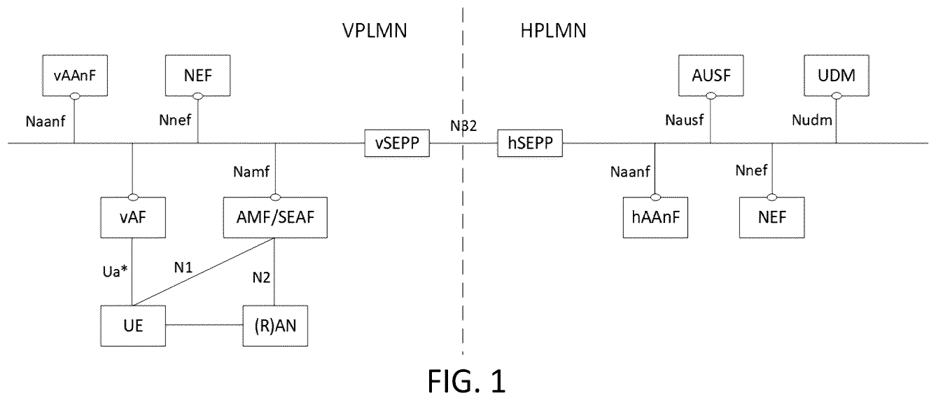

FIG. 1 shows an SBA (Service Based Architecture) of 5GS (5G system) for a roaming UE accessing application function. The 5GS shown in FIG. 1 comprises the following network functions (NF):

The Access and Mobility Management function (AMF) includes functionalities such as: UE mobility management, reachability management, connection management, etc.

The Security Anchor Function (SEAF) in the serving network stores the anchor key called the KSEAF provided by the AUSF of the home network. The KSEAF is derived from keying material generated by the primary authentication and key agreement procedure.

The Authentication Server Function (AUSF) supports authentication for 3GPP access and untrusted non-3GPP access. In an AKMA architecture, the AUSF provides a Subscription Permanent Identifier (SUPI) and AKMA key material (e.g., AKMA key ID (A-KID) and/or AKMA Anchor Key (K_{AKMA})) of the UE to the AAnF. The AUSF also performs the AAnF selection.

The AKMA Anchor Function (AAnF) stores the AKMA key materials (e.g., K_{AKMA} and/or the SUPI) of the UE for the AKMA service, where the AKMA key material is received from the AUSF after the UE completes a successful 5G primary authentication. The AAnF also generates the AKMA key material to be used between the UE and the Application Function (AF) and maintains UE AKMA contexts. The AAnF sends the SUPI of the UE to the AF located inside the network of the network operator according to a request from the or sends the SUPI to the network exposure function (NEF).

The Unified Data Management (UDM) stores the subscription profile for the UEs. In the AKMA architecture, the UDM stores AKMA subscription data of the subscriber.

As discussed in the background section, though the UE can connect to two different visited networks, the UE may leverage only one visited network to connect to a target AF. Under such conditions, certain multiple registration problems in the AKMA roaming scenario may emerge.

For example, the UE firstly registers with a VPLMN1 through a 3GPP access (e.g. trusted access) and the AAnF stores an SN-name of the VPLMN1. When the UE initiates the AKMA service in the VPLMN1, the AAnF can transfer the AKMA key information to NF(s) in the VPLMN1.

If the UE is registered with the VPLMN2 through a non-3GPP access (e.g., untrusted access) at the same time, the AAnF overwrites the SN-name of the VPLMN1 and stores the SN-name of the VPLMN2. In this case, no matter the UE initiates the AKMA service through the VPLMN1 or the VPLMN2, the AAnF always transfers the AKMA key information to NF(s) in the VPLMN2. If the VPLMN1 is configured with the supervisory service, the supervisory service cannot be implemented.

Similarly, when the UE roams from the VPLMN1 to another VPLMN3 through the 3GPP access, the AAnF overwrites the SN-name of the VPLMN2 and stores the SN-name of the VPLMN3 if the primary authentication is triggered. Under such conditions, no matter whether the UE initiates the AKMA service through the VPLMN2 or the VPLMN3, the AAnF always transfers the AKMA key information to NF(s) in the VPLMN3. If the supervisory service is set on the VPLMN2, the supervisory service cannot be implemented.

In the present disclosure, a method for multiple registration problems in the AKMA roaming scenario is disclosed.

In an embodiment, the AAnF stores a parameter “Access Type”, to indicate whether the access is via 3GPP/non-3GPP access. For each Access Type, the AAnF stores the latest corresponding SN-name information. Note that the access type may not be limited to the 3GPP access (e.g., trusted access) or non-3GPP access (untrusted access) and may comprise other types of access.

In an embodiment, no matter through which VPLMN the UE initiates the AKMA service, the AAnF transfers the AKMA key material to the VPLMN(s) based on the latest SN-name information of each access type. If there is the latest SN-name information for just single Access Type, the AAnF transfers the AKMA key material to the VPLMN with this SN-name. If there is the latest SN-name information for multiple Access Types (e.g., 3GPP access and non-3GPP access), the AAnF transfers the AKMA key material to the multiple VPLMNs according to the latest SN-name information.

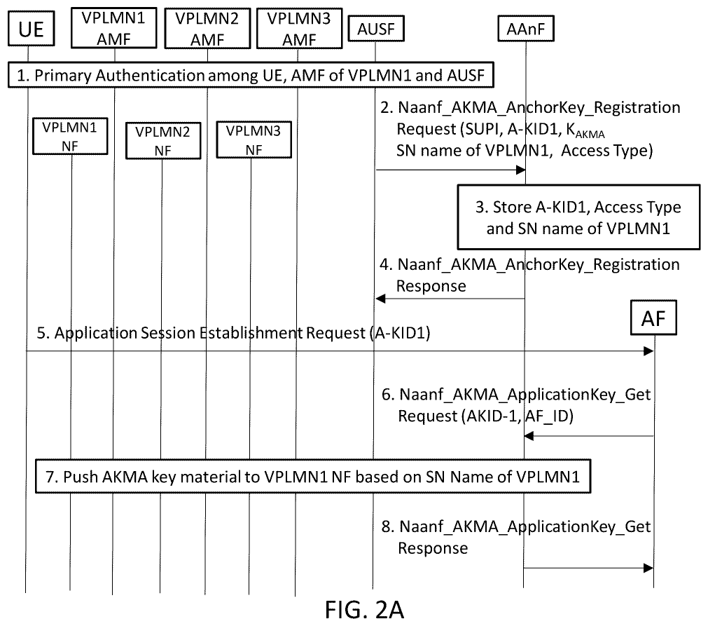

FIGS. 2A to 2C show schematic diagrams of a process according to an embodiment of the present disclosure. The process shown in FIGS. 2A to 2C comprises the following steps:

Steps 1-8 in FIG. 2A: The UE registers with the VPLMN1 through the 3GPP Access Type.
Step 1: The UE is authenticated through the 3GPP Access Type in a VPLMN1.
Step 2: After AKMA key material is generated, the AUSF selects an AAnF, sends the generated A-KID1, K_{AKMA}, the SN-name of the VPLMN1 and corresponding Access Type (i.e., 3GPP Access Type) to the AAnF together with the SUPI of the UE by using the Naanf_AKMA_KeyRegistration Request service operation.
Step 3: The AAnF stores the latest information sent by the AUSF. Note that the stored information includes the SN-name and corresponding Access Type of the VPLMN1.
Step 4: The AAnF sends a response to the AUSF by using the Naanf_AKMA_AnchorKey_Register Response service operation.
Step 5: The UE generates the K_{AKMA} and the A-KID1 received from the K_{AUSF} before initiating communications with an AKMA Application Function (AF). When/If the UE initiates the AKMA service in the VPLMN1 to communicate with the AKMA AF, the UE includes the derived A-KID1 in an Application Session Establishment Request message. The UE may derive a K_{AF} before sending the message or afterwards.
Step 6: If the AF does not have an active context associated with the A-KID1, the AF selects the AAnF and sends a Naanf_AKMA_ApplicationKey_Get request to the AAnF with the A-KID1, to request the K_{AF} for the UE. The AF may also include its identity (i.e., AF_ID) in the request.
Step 7: The AAnF derives the K_{AF} from the K_{AKMA} if the AAnF does not have the K_{AF}. In an embodiment, the AAnF needs to push the AKMA key material to an NF of the VPLMN1 based on the SN-name of VPLMN1 if the AAnF is required to provide supervisory information to the VPLMN1. For example, the NF in the VPLMN1 to which the AKMA key material is pushed may be an AMF, an AAnF or other new NF in the VPLMN1.
Step 8: The AAnF sends a Naanf_AKMA_ApplicationKey_Get response to the AF with the SUPI, K_{AF} and the K_{AF} expiration time.
Steps 9-16 in FIG. 2B: If the UE wants to register with a VPLMN2 through a non-3GPP Access Type at the same time, steps 9-16 are executed.
Step 9: The UE is authenticated through the non-3GPP Access Type in the VPLMN2.
Step 10: After the AKMA key material is generated, the AUSF sends the generated A-KID2, new K_{AKMA}, the SN-name of the VPLMN2 and corresponding Access Type (i.e., non-3GPP access) to the AAnF together with the SUPI of the UE by using the Naanf_AKMA_KeyRegistration Request service operation.
Step 11: The AAnF overwrites the K_{AKMA} as the newly received one, overwrites the A-KID1 as A-KID2 and stores the SN-name and the corresponding Access Type of the VPLMN2.

Specifically, the AAnF checks whether it has the SN-name information corresponding to the received Access Type and the SUPI. If there is no existing SN-name information corresponding to this Access Type and the SUPI, the AAnF stores the SN-name and the corresponding Access Type.
Step 12: The AAnF sends the response to the AUSF by using the Naanf_AKMA_AnchorKey_Register Response service operation.
Step 13: The UE generates a new K_{AKMA} and the A-KID2 from the K_{AUSF} before initiating communications with the AKMA AF and overwrites the K_{AKMA} and A-KID1 generated in step 5. When/If the UE initiates the AKMA service via the VPLMN1 or the VPLMN2 to communicate with the AKMA AF, the UE includes the derived A-KID2 in the Application Session Establishment Request message. The UE may derive K_{AF} from the new K_{AKMA} before sending the message or afterwards.
Step 14: If the AF does not have an active context associated with the A-KID2, the AF sends a Naanf_AKMA_ApplicationKey_Get request to the AAnF with the A-KID2 to request the K_{AF} for the UE. The AF may also include its identity (i.e., AF_ID) in the request.
Step 15: The AAnF derives the K_{AF} from K_{AKMA} if the AAnF does not have the K_{AF}. Note that the AAnF needs to push the AKMA key material to the NFs in both VPLMN1 and VPLMN2 based on the SN-names and corresponding Access Types it has stored if the AAnF is required to provide the supervisory information.

For example, the NF may be the AMF, the AAnF or other new NF in the VPLMN1 and/or the VPLMN2.
Step 16: The AAnF sends Naanf_AKMA_ApplicationKey_Get response to the AF with the SUPI, the K_{AF} and the K_{AF} expiration time.

Steps 17-24 in FIG. 2C: If the UE roams from the VPLMN1 to another VPLMN3 and registers through the 3GPP access, steps 17 to 24 are executed.
Step 17: The UE is authenticated through the 3GPP Access Type in the VPLMN3.
Step 18: After AKMA key material is generated, the AUSF sends the generated A-KID3, new K_{AKMA}, the SN-name of the VPLMN3 and the corresponding Access Type to the AAnF together with the SUPI of the UE by using the Naanf_AKMA_KeyRegistration Request service operation.
Step 19: The AAnF overwrites the K_{AKMA} as the newly received one, overwrites the A-KID2 as the A-KID3, and overwrites the stored SN-name and the corresponding Access Type of the VPLMN1 as the received SN-name and the Access Type of the VPLMN3.

Particularly, the AAnF checks whether it has the SN-name information corresponding to the received Access Type (i.e., 3GPP access type) and the SUPI. Since there is existing SN-name information corresponding to the received Access Type, the AAnF overwrites the SN-name as the received SN-name of the VPLMN3.
Step 20: The AAnF sends the response to the AUSF by using the Naanf_AKMA_AnchorKey_Register Response service operation.
Step 21: The UE generates a new K_{AKMA} and the A-KID3 from the K_{AUSF} before initiating communication with an AKMA Application Function, and overwrites the K_{AKMA} and A-KID2 generated in step 13. When the UE initiates AKMA service via VPLMN2 or VPLMN3 to communicate with the AKMA AF, the UE includes the derived A-KID3 in the Application Session Establishment Request message. The UE may derive K_{AF} from the new K_{AKMA} before sending the message or afterwards.
Step 22: If the AF does not have an active context associated with the A-KID3, the AF sends a Naanf_AKMA_ApplicationKey_Get request to the AAnF with the A-KID3 to request the K_{AF} for the UE. The AF may also include its identity (i.e., AF_ID) in the request.
Step 23: The AAnF derives the K_{AF} from the K_{AKMA} if the AAnF does not have K_{AF}. AAnF needs to push the AKMA key material to the NFs in both the VPLMN2 and the VPLMN3 NF based on the SN-names and the corresponding Access Types it has stored if the AAnF is required to provide the supervisory information.

Note that the NFs in the VPLMN2 and/or VPLMN3 may be the AMF, the AAnF or other new NF in the VPLMN2 and/or VPLMN3.
Step 24: The AAnF sends the Naanf_AKMA_ApplicationKey_Get response to the AF with the SUPI, K_{AF} and the K_{AF} expiration time.

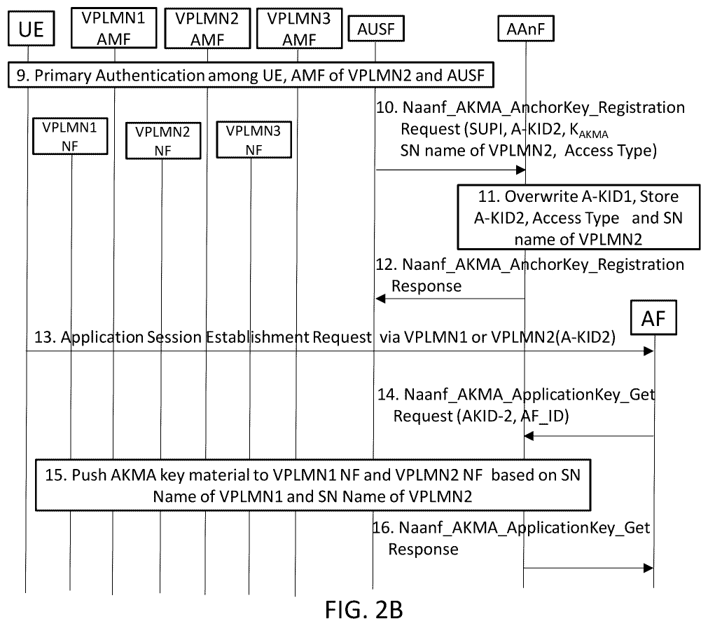

FIG. 3 relates to a schematic diagram of a wireless terminal 30 according to an embodiment of the present disclosure. The wireless terminal 30 may be a user equipment (UE), a mobile phone, a laptop, a tablet computer, an electronic book or a portable computer system and is not limited herein. The wireless terminal 30 may include a processor 300 such as a microprocessor or Application Specific Integrated Circuit (ASIC), a storage unit 310 and a communication unit 320. The storage unit 310 may be any data storage device that stores a program code 312, which is accessed and executed by the processor 300. Embodiments of the storage unit 310 include but are not limited to a subscriber identity module (SIM), read-only memory (ROM), flash memory, random-access memory (RAM), hard-disk, and optical data storage device. The communication unit 320 may a transceiver and is used to transmit and receive signals (e.g., messages or packets) according to processing results of the processor 300. In an embodiment, the communication unit 320 transmits and receives the signals via at least one antenna 322 shown in FIG. 3.

In an embodiment, the storage unit 310 and the program code 312 may be omitted and the processor 300 may include a storage unit with stored program code.

The processor 300 may implement any one of the steps in exemplified embodiments on the wireless terminal 30, e.g., by executing the program code 312.

The communication unit 320 may be a transceiver. The communication unit 320 may as an alternative or in addition be combining a transmitting unit and a receiving unit configured to transmit and to receive, respectively, signals to and from a wireless network node (e.g., a base station).

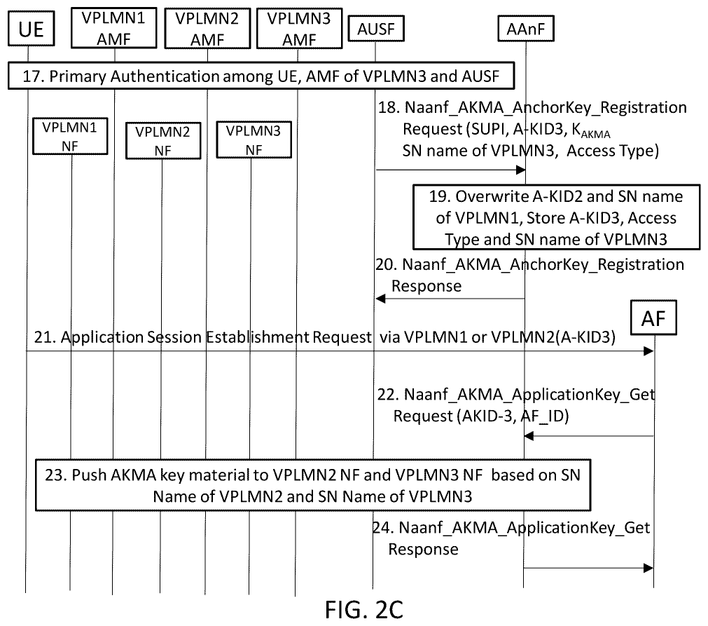

FIG. 4 relates to a schematic diagram of a wireless network node 40 according to an embodiment of the present disclosure. The wireless network node 40 may be a satellite, a base station (BS), a network entity, a Mobility Management Entity (MME), Serving Gateway (S-GW), Packet Data Network (PDN) Gateway (P-GW), a radio access network (RAN) node, a next generation RAN (NG-RAN) node, a gNB, an eNB, a gNB central unit (gNB-CU), a gNB distributed unit (gNB-DU) a data network, a core network or a Radio Network Controller (RNC), and is not limited herein. In addition, the wireless network node 40 may comprise (perform) at least one network function such as an access and mobility management function (AMF), a session management function (SMF), a user place function (UPF), a policy control function (PCF), an application function (AF), etc. The wireless network node 40 may include a processor 400 such as a microprocessor or ASIC, a storage unit 410 and a communication unit 420. The storage unit 410 may be any data storage device that stores a program code 412, which is accessed and executed by the processor 400. Examples of the storage unit 410 include but are not limited to a SIM, ROM, flash memory, RAM, hard-disk, and optical data storage device. The communication unit 420 may be a transceiver and is used to transmit and receive signals (e.g., messages or packets) according to processing results of the processor 400. In an example, the communication unit 420 transmits and receives the signals via at least one antenna 422 shown in FIG. 4.

In an embodiment, the storage unit 410 and the program code 412 may be omitted. The processor 400 may include a storage unit with stored program code.

The processor 400 may implement any steps described in exemplified embodiments on the wireless network node 40, e.g., via executing the program code 412.

The communication unit 420 may be a transceiver. The communication unit 420 may as an alternative or in addition be combining a transmitting unit and a receiving unit configured to transmit and to receive, respectively, signals to and from a wireless terminal (e.g., a user equipment or another wireless network node).

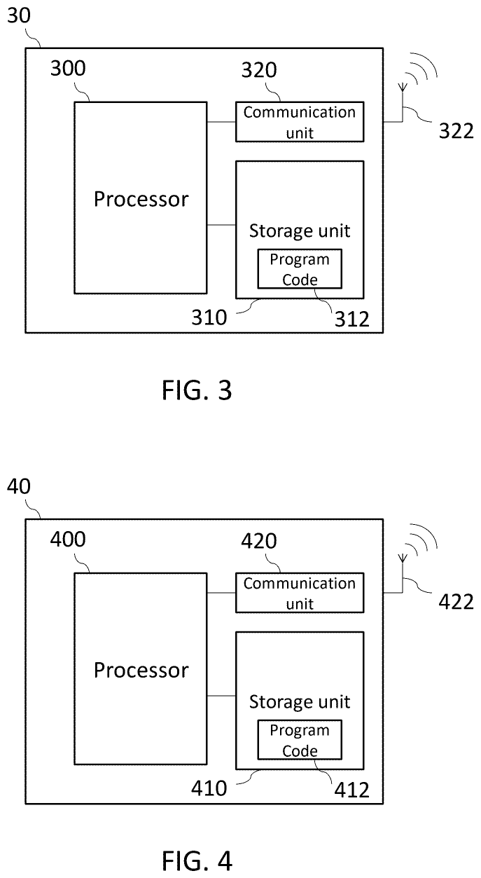

FIG. 5 shows a flowchart of a method according to an embodiment of the present disclosure. The method shown in FIG. 5 may be used in an anchor function (e.g., AAnF, a wireless device comprising the AAnF or a wireless device performing at least part of functionalities of the AAnF) and comprises the following step:
Step 501: Receive, from an AUSF, a first key registration request for a wireless terminal, wherein the first key registration request comprises a first serving network name of a first visited network and a first access type associated with the first visited network.
Step 502: Store the first serving network name as a current network corresponding to the first access type for the wireless terminal.

In FIG. 5, the anchor function receives a first key registration request (e.g., Naanf_AKMA_KeyRegistration Request) for a wireless terminal (e.g., UE) from an AUSF. The first key registration request comprises a first serving network name of a first visited network (e.g., VPLMN) and a first access type associated with the first visited network. The first access type is one of a plurality of access types. The anchor function stores the first serving network name as a current network corresponding to the first access type for the wireless terminal. That is the anchor function records the latest serving network name of each access type for the wireless terminal. Note that the serving network name may be replaced by any serving network information associated with (e.g., able to distinguish) the visited network.

In an embodiment, the anchor function is in a home network (e.g., HPLMN).

In an embodiment, the plurality of access types comprises a trusted access type (e.g., 3GPP access type) and an untrusted access type (e.g., non-3GPP access type).

In an embodiment, the anchor function transmits key information (e.g., K_{AKMA} and A-KID) of the wireless terminal to a plurality of network functions based on the current networks corresponding to the plurality of access types. In an embodiment, the network function may be the AMF or AUSF in the corresponding network. In other words, if the anchor function needs to transmit the key information of the wireless terminal, the anchor function transmits/pushes, based on the stored SN names, the key information to the NF in the visited networks corresponding to the plurality of access types.

In an embodiment, the anchor function transmits the key information of the wireless terminal in response to a reception of a key acquisition request for the wireless terminal from an AF (in the home network).

In an embodiment, the anchor function receives a second key registration request for the wireless terminal from the AUSF. The second key registration request comprises a second serving network name of a second visited network and a second access type associated with the second visited network. In this embodiment, the second access type is one of the plurality of access types and is different from the first access type. The anchor function stores the second serving network name as a current network corresponding to the second access type for the wireless terminal. Note that, because the second access type is different from the first access type, the anchor function does not overwrite the current network corresponding to the first access type by the second serving network name (i.e., second visited network). Under such conditions, if the anchor function needs to transmit the key information of the wireless terminal (e.g. if receiving a key acquisition request for the wireless terminal from the AF), the anchor function transmits the key information of the wireless terminal to a first network function of the current network corresponding to the first access type (i.e., first visited network) and to a second network function of the current network corresponding to the second access type (i.e., second visited network).

In an embodiment, the anchor function receives a third key registration request for the wireless terminal from the AUSF. The third key registration request comprises a third serving network name of a third visited network and a third access type associated with the second visited network. In this embodiment, the third access type is equal to the first access type. The anchor function stores the third serving network name as the current network corresponding to the first/third access type for the wireless terminal. Note that, because the third access type and the first access type are the same, the anchor function overwrites the current network corresponding to the first access type by the third serving network name (i.e., third visited network). Under such conditions, if the anchor function needs to transmit the key information of the wireless terminal (e.g. if receiving a key acquisition request for the wireless terminal from the AF), the anchor function transmits the key information of the wireless terminal to a third network function of the current network corresponding to the first/third access type (i.e., third visited network) and to the second network function of the current network corresponding to the second access type (i.e., second visited network).

In an embodiment, the first key registration request further comprises a first anchor key (e.g., K_{AKMA}) and a first key identifier (e.g., A-KID) and the anchor function stores the first anchor key as a current anchor key of the wireless terminal and stores the first anchor key identifier as a current anchor key identifier of the wireless terminal.

In an embodiment, the anchor function receives, from the AUSF, a fourth key registration request (e.g., either the second key registration request or the third key registration request) for the wireless terminal. The fourth key registration request comprises a second anchor key (e.g., K_{AKMA}) and a second key identifier (e.g., A-KID). In this embodiment, the anchor function stores the second anchor key as the current anchor key of the wireless terminal and stores the second anchor key identifier as the current anchor key identifier of the wireless terminal. Note that the fourth key registration request is associated with a fourth visited network (e.g., having a fourth SN name of the fourth visited network) which has a fourth access type different from or the same with the first access type. That is, no matter whether the latest/received key registration request is associated with the same or different access types, the anchor function always overwrites the anchor key and the key identifier (i.e., key information) by the anchor key and the key identifier comprised in the latest/received key registration request.

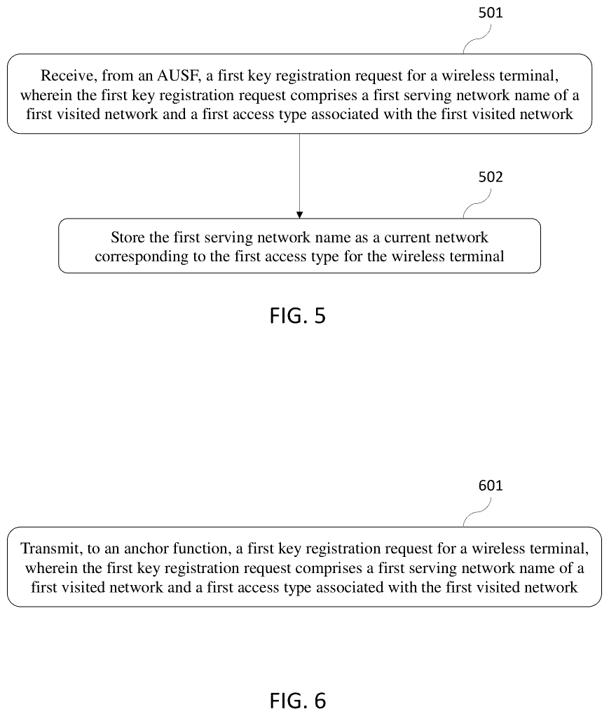

FIG. 6 shows a flowchart of a method according to an embodiment of the present disclosure. The method shown in FIG. 6 may be used in an AUSF (e.g., a wireless device comprising the AUSF or the wireless device performing at least part of functionalities of the AUSF) and comprises the following step:
Step 601: Transmit, to an anchor function, a first key registration request for a wireless terminal, wherein the first key registration request comprises a first serving network name of a first visited network and a first access type associated with the first visited network.

In FIG. 6, the AUSF transmits a first key registration request for a wireless terminal (e.g. UE) to an anchor function (e.g., AAnF). The first key registration request comprises a first serving network name of a first visited network and a first access type associated with the first visited network. In an embodiment, the first access type is one of a plurality of access types.

In an embodiment, the plurality of access types comprises a trusted access type (e.g., 3GPP access type) and an untrusted access type (e.g., non-3GPP access type).

In an embodiment, the AUSF further transmits a second key registration request for the wireless terminal to the anchor function. The second key registration request comprises a second serving network name of a second visited network and a second access type associated with the second visited network. In this embodiment, the second access type is one of the plurality of access types and is different from the first access type.

In an embodiment, the AUSF further transmits a third key registration request for the wireless terminal to the anchor function. The third key registration request comprises a third serving network name of a third visited network and a third access type associated with the third visited network. In this embodiment, the third access type is one of the plurality of access types and is the same with the first access type.

In an embodiment, the first key registration request further comprises a first anchor key (e.g., K_{AKMA}) and a first key identifier (A-KID).

In an embodiment, the AUSF transmits a fourth key registration request for the wireless terminal to the anchor function. The fourth key registration request comprises a second anchor key (e.g., K_{AKMA}) and a second key identifier (A-KID).

In an embodiment, the fourth key registration request is associated with a fourth visited network which has a fourth access type different from or the same with the first access type.

While various embodiments of the present disclosure have been described above, it should be understood that they have been presented by way of example only, and not by way of limitation. Likewise, the various diagrams may depict an example architectural or configuration, which are provided to enable persons of ordinary skill in the art to understand exemplary features and functions of the present disclosure. Such persons would understand, however, that the present disclosure is not restricted to the illustrated example architectures or configurations, but can be implemented using a variety of alternative architectures and configurations. Additionally, as would be understood by persons of ordinary skill in the art, one or more features of one embodiment can be combined with one or more features of another embodiment described herein. Thus, the breadth and scope of the present disclosure should not be limited by any one of the above-described exemplary embodiments.

It is also understood that any reference to an element herein using a designation such as “first,” “second,” and so forth does not generally limit the quantity or order of those elements. Rather, these designations can be used herein as a convenient means of distinguishing between two or more elements or instances of an element. Thus, a reference to first and second elements does not mean that only two elements can be employed, or that the first element must precede the second element in some manner.

Additionally, a person having ordinary skill in the art would understand that information and signals can be represented using any one of a variety of different technologies and techniques. For example, data, instructions, commands, information, signals, bits and symbols, for example, which may be referenced in the above description can be represented by voltages, currents, electromagnetic waves, magnetic fields or particles, optical fields or particles, or any combination thereof.

A skilled person would further appreciate that any one of the various illustrative logical blocks, units, processors, means, circuits, methods and functions described in connection with the aspects disclosed herein can be implemented by electronic hardware (e.g., a digital implementation, an analog implementation, or a combination of the two), firmware, various forms of program or design code incorporating instructions (which can be referred to herein, for convenience, as “software” or a “software unit”), or any combination of these techniques.

To clearly illustrate this interchangeability of hardware, firmware and software, various illustrative components, blocks, units, circuits, and steps have been described above generally in terms of their functionality. Whether such functionality is implemented as hardware, firmware or software, or a combination of these techniques, depends upon the particular application and design constraints imposed on the overall system. Skilled artisans can implement the described functionality in various ways for each particular application, but such implementation decisions do not cause a departure from the scope of the present disclosure. In accordance with various embodiments, a processor, device, component, circuit, structure, machine, unit, etc. can be configured to perform one or more of the functions described herein. The term “configured to” or “configured for” as used herein with respect to a specified operation or function refers to a processor, device, component, circuit, structure, machine, unit, etc. that is physically constructed, programmed and/or arranged to perform the specified operation or function.

Furthermore, a skilled person would understand that various illustrative logical blocks, units, devices, components and circuits described herein can be implemented within or performed by an integrated circuit (IC) that can include a general purpose processor, a digital signal processor (DSP), an application specific integrated circuit (ASIC), a field programmable gate array (FPGA) or other programmable logic device, or any combination thereof. The logical blocks, units, and circuits can further include antennas and/or transceivers to communicate with various components within the network or within the device. A general purpose processor can be a microprocessor, but in the alternative, the processor can be any conventional processor, controller, or state machine. A processor can also be implemented as a combination of computing devices, e.g., a combination of a DSP and a microprocessor, a plurality of microprocessors, one or more microprocessors in conjunction with a DSP core, or any other suitable configuration to perform the functions described herein. If implemented in software, the functions can be stored as one or more instructions or code on a computer-readable medium. Thus, the steps of a method or algorithm disclosed herein can be implemented as software stored on a computer-readable medium.

Computer-readable media includes both computer storage media and communication media including any medium that can be enabled to transfer a computer program or code from one place to another. A storage media can be any available media that can be accessed by a computer. By way of example, and not limitation, such computer-readable media can include RAM, ROM, EEPROM, CD-ROM or other optical disk storage, magnetic disk storage or other magnetic storage devices, or any other medium that can be used to store desired program code in the form of instructions or data structures and that can be accessed by a computer.

In this document, the term “unit” as used herein, refers to software, firmware, hardware, and any combination of these elements for performing the associated functions described herein. Additionally, for purpose of discussion, the various units are described as discrete units; however, as would be apparent to one of ordinary skill in the art, two or more units may be combined to form a single unit that performs the associated functions according embodiments of the present disclosure.

Additionally, memory or other storage, as well as communication components, may be employed in embodiments of the present disclosure. It will be appreciated that, for clarity purposes, the above description has described embodiments of the present disclosure with reference to different functional units and processors. However, it will be apparent that any suitable distribution of functionality between different functional units, processing logic elements or domains may be used without detracting from the present disclosure. For example, functionality illustrated to be performed by separate processing logic elements, or controllers, may be performed by the same processing logic element, or controller. Hence, references to specific functional units are only references to a suitable means for providing the described functionality, rather than indicative of a strict logical or physical structure or organization.

Various modifications to the implementations described in this disclosure will be readily apparent to those skilled in the art, and the general principles defined herein can be applied to other implementations without departing from the scope of the claims. Thus, the disclosure is not intended to be limited to the implementations shown herein, but is to be accorded the widest scope consistent with the novel features and principles disclosed herein, as recited in the claims below.

1. A wireless communication method for use in an anchor function, the method comprising:
receiving, from an authentication server function, a first key registration request for a wireless terminal, wherein the first key registration request comprises a first serving network name of a first visited network and a first access type associated with the first visited network, wherein the first access type is one of a plurality of access types, and
storing the first serving network name as a current network corresponding to the first access type for the wireless terminal.

2. The wireless communication method of claim 1, wherein the plurality of access types comprises a trusted access type and an untrusted access type.

3. The wireless communication method of claim 1, further comprising at least one of:
receiving, from an application function, a key acquisition request for the wireless terminal, and
transmitting key information of the wireless terminal to a plurality of network functions based on the current networks corresponding to the plurality of access types;
receiving, from an application function, a key acquisition request for the wireless terminal, and transmitting key information of the wireless terminal to a first network function of the current network corresponding to the first access type.

4. (canceled)

5. The wireless communication method of claim 1, further comprising at least one of:
receiving, from the authentication server function, a second key registration request for the wireless terminal, wherein the second key registration request comprises a second serving network name of a second visited network and a second access type associated with the second visited network, wherein the second access type is one of the plurality of access types and is different from the first access type, and
storing the second serving network name as a current network corresponding to the second access type for the wireless terminal;
receiving, from the authentication server function, a third key registration request for the wireless terminal, wherein the third key registration request comprises a third serving network name of a third visited network and the first access type associated with the third visited network, and storing the third serving network name as the current network corresponding to the first access type for the wireless terminal.

6. The wireless communication method of claim 5, further comprising:
receiving, from an application function, a key acquisition request for the wireless terminal, and
transmitting key information of the wireless terminal to a first network function of the current network corresponding to the first access type, and
transmitting the key information of the wireless terminal to a second network function of the current network corresponding to the second access type.

7. (canceled)

8. The wireless communication method of claim 5, further comprising:
receiving, from an application function, a key acquisition request for the wireless terminal, and
transmitting key information of the wireless terminal to a third network function of the current network corresponding to the first access type, and
transmitting the key information of the wireless terminal to a second network function of the current network corresponding to the second access type.

9. The wireless communication method of claim 1, wherein the first key registration request further comprises a first anchor key and a first key identifier, and
wherein the method further comprises:
storing the first anchor key as a current anchor key of the wireless terminal, and
storing the first anchor key identifier as a current anchor key identifier of the wireless terminal.

10. The wireless communication method of claim 9, further comprising:
receiving, from the authentication server function, a fourth key registration request for the wireless terminal, wherein the fourth key registration request comprises a second anchor key and a second key identifier,
storing the second anchor key as the current anchor key of the wireless terminal, and
storing the second anchor key identifier as the current anchor key identifier of the wireless terminal.

11. The wireless communication method of claim 10, wherein the fourth key registration request is associated with a fourth visited network which has a fourth access type different from or the same with the first access type.

12. A wireless communication method for use in an authentication server function, the method comprising:
transmitting, to an anchor function, a first key registration request for a wireless terminal, wherein the first key registration request comprises a first serving network name of a first visited network and a first access type associated with the first visited network, wherein the first access type is one of a plurality of access types.

13. The wireless communication method of claim 12, wherein the plurality of access types comprises a trusted access type and an untrusted access type.

14. The wireless communication method of claim 12, further comprising:
transmitting, to the anchor function, a second key registration request for the wireless terminal, wherein the second key registration request comprises a second serving network name of a second visited network and a second access type associated with the second visited network, wherein the second access type is one of the plurality of access types and is different from the first access type.

15. The wireless communication method of claim 12, further comprising:
transmitting, to the anchor function, a third key registration request for the wireless terminal, wherein the third key registration request comprises a third serving network name of a third visited network and the first access type associated with the third visited network.

16. The wireless communication method of claim 12, wherein the first key registration request further comprises a first anchor key and a first key identifier.

17. The wireless communication method of claim 12, further comprising:
transmitting, to the anchor function, a fourth key registration request for the wireless terminal, wherein the fourth key registration request comprises a second anchor key and a second key identifier.

18. The wireless communication method of claim 17, wherein the fourth key registration request is associated with a fourth visited network which has a fourth access type different from or the same with the first access type.

19. (canceled)

20. (canceled)

21. (canceled)

22. (canceled)

23. A non-transitory computer-readable medium, comprising software stored thereupon, the software, when executed by a processor, causing the processor to implement a wireless communication method recited in claim 1.

24. A non-transitory computer-readable medium, comprising software stored thereupon, the software, when executed by a processor, causing the processor to implement a wireless communication method recited in claim 12.

25. An electronic device, comprising: a processor and a memory, wherein the memory stores a computer-readable program medium code, and the code, when executed by the processor, causes the processor to implement a wireless communication method recited in claim 1.

26. An electronic device, comprising: a processor and a memory, wherein the memory stores a computer-readable program medium code, and the code, when executed by the processor, causes the processor to implement a wireless communication method recited in claim 12.
